(19) United States
(12) Patent Application Publication
(10) Pub. No.: US 2016/0171043 A1
(43) Pub. Date: Jun. 16, 2016

(54) TEMPLATE GENERATION IN ELECTRONIC DEVICE

(71) Applicant: Samsung Electronics Co., Ltd., Gyeonggi-do (KR)

(72) Inventors: Jin Mook LIM, Gyeonggi-do (KR); Yoo Mi NOH, Gyeonggi-do (KR); Kyung Sub MIN, Gyeonggi-do (KR); Eun Jung HYUN, Seoul (KR)

(21) Appl. No.: 14/964,850

(22) Filed: Dec. 10, 2015

(30) Foreign Application Priority Data
Dec. 12, 2014 (KR) 10-2014-0179717

(51) Int. Cl. G06F 17/30; G06F 7/24

(52) U.S. Cl. CPC G06F 17/30392; G06F 17/3053; G06F 7/24; G06F 17/30867

(57) ABSTRACT

Disclosed herein is a method for generating a template, and an electronic device and storage medium implementing the same. The method includes extracting, by at least one processor, an entity from content, determining a template based on a type of the extracted entity, and displaying on a display the determined template, wherein the extracted entity is provided to at least one field of the determined template.

### CLAIM OF PRIORITY

This application claims the benefit under 35 U.S.C. §119(a) of a Korean patent application filed on Dec. 12, 2014 in the Korean Intellectual Property Office and assigned Serial number 10-2014-0179717, the entire disclosure of which is hereby incorporated by reference.

### TECHNICAL FIELD

The present disclosure relates to template generation in an electronic device.

### BACKGROUND

An electronic device (e.g., smart phone, tablet PC, etc.) may execute applications to perform various functions. An electronic device may provide a specific template into which a user is able to insert schedule, memo, alarm, etc., the template insertable into applications such as schedule application, memo application, alarm application, etc. In this case, the user may input information into a template and add the respective schedule, memo, alarm, and so on. To add the schedule, memo, etc. by a user while executing a real-time voice or chat application, such as message application, application changeover is executed which requires input and storage of data and other information contents. Additionally, after storing the schedule, memo, etc., the user may return to the message application to append schedule files and memo files to messages.

### SUMMARY

In one aspect of the present invention, a method in an electronic device is disclosed, including: extracting, by at least one processor, an entity from content, determining a template based on a type of the extracted entity, and displaying on a display the determined template, wherein the extracted entity is provided to at least one field of the determined template.

In an aspect of the present invention, an electronic device is disclosed, including a display, a memory, and at least one processor coupled to the memory, configured to: control the display to display a list of templates, each template including fields for receiving data, and in response to determining selection of a particular template from the list, controlling the display to display the particular template wherein data is automatically provided to at least one field of the particular template.

In an aspect of the present invention, a non-transitory computer-readable storage medium including an instruction to control an electronic device, wherein the instruction causes the electronic device to perform: extracting, by at least one processor, an entity from content, determining a template list corresponding to a type of the extracted entity, and displaying on a display the determined template, wherein the extracted entity is provided to at least one field of the determined template.

According to various embodiments of the present disclosure, it may be allowable to provide a template, into which a text of a screen is automatically input, to a user and to simply use important information. According to various embodiments of the present disclosure, it may be permissible to easily input a template into a currently used screen without additional application changeover and to transmit information, such as schedule, memo, alarm, and so on, to the other device. Other aspects and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic device in a network environment according to various embodiments of the present disclosure;

FIG. 2 is a block diagram illustrating a template processing module according to various embodiments of the present disclosure;

FIG. 3 is a flow chart showing a template generation process according to various embodiments of the present disclosure;

FIG. 4A is an example diagram illustrating a template generation process in a message application according to various embodiments of the present disclosure;

FIG. 4B is an example diagram illustrating a template generation process in a call application according to various embodiments of the present disclosure;

FIG. 5 is a flow chart showing a template display and generation process using entities according to various embodiments of the present disclosure;

FIG. 6A is an example diagram illustrating a template display and generation process using entities in a message application according to various embodiments of the present disclosure;

FIG. 6B is an example diagram illustrating a template display and generation process using entities in a call application according to various embodiments of the present disclosure;

FIG. 7 is a flow chart showing a template generation process using entities according to various embodiments of the present disclosure;

FIG. 8A is an example diagram illustrating a template generation process using entities in a message application according to various embodiments of the present disclosure;

FIG. 8B is an example diagram illustrating a template generation process using entities in a call application according to various embodiments of the present disclosure;

FIG. 9 is an example diagram illustrating a template generation process according to various embodiments of the present disclosure; and

FIG. 10 is a block diagram illustrating an electronic device according to various embodiments of the present disclosure.

### DETAILED DESCRIPTION

Hereinafter, various embodiments of the present disclosure will be described in conjunction with the accompanying drawings. Various embodiments described herein, however, may not be intentionally confined in specific embodiments, but should be construed as including diverse modifications, equivalents, and/or alternatives. With respect to the descriptions of the drawings, like reference numerals refer to like elements.

The terms “have”, “may have”, “include”, “may include”, “comprise,” or “may comprise” used herein indicate existence of corresponding features (e.g., numerical values, functions, operations, or components) but does not exclude other features.

As used herein, the terms “A or B”, “at least one of A or/and B”, or “one or more of A or/and B” may include all allowable combinations which are enumerated together. For example, the terms “A or B”, “at least one of A and B”, or “at least one of A or B” may indicate all cases of: (1) including at least one A, (2) including at least one B, or (3) including both at least one A, and at least one B.

As used herein, the terms such as “1st”, “2nd”, “first”, “second”, and the like may be used to qualify various elements regardless of their order and/or priority, simply differentiating one from another, but do not limit those elements thereto. For example, both a first user device and a second user device indicate different user devices. For example, a first component may be referred to as a second component and vice versa without departing from the present disclosure.

As used herein, if one element (e.g., a first element) is referred to as being “operatively or communicatively connected with/to” or “connected with/to” another element (e.g., a second element), it should be understood that the former may be directly coupled with the latter, or connected with the latter via an intervening element (e.g., a third element). Otherwise, it will be understood that if one element is referred to as being “directly coupled with/to” or “directly connected with/to” with another element, it may be understood that there is no intervening element existing between them.

In the description or claims, the term “configured to” (or “set to”) may be changeable with other implicative meanings such as “suitable for”, “having the capacity to”, “designed to”, “adapted to”, “made to”, or “capable of”, and may not simply indicate “specifically designed to”. Alternatively, in some circumstances, a term “a device configured to” may indicate that the device “may do” something together with other devices or components. For instance, a term “a processor configured to (or set to) perform A, B, and C” may indicate a generic-purpose processor (e.g., CPU or application processor) capable of performing its relevant operations by executing one or more software or programs which is stored in an exclusive processor (e.g., embedded processor), which is prepared for the operations, or in a memory.

The terms used in this specification are just used to describe various embodiments of the present disclosure and may not be intended to limit the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevantly related art and not in an idealized or overly formal detect unless expressly so defined herein in various embodiments of the present disclosure. In some cases, terms even defined in the specification may not be understood as excluding embodiments of the present disclosure.

An electronic device according to various embodiments of the present disclosure may include, for example, at least one of smartphones, tablet personal computers (tablet PCs), mobile phones, video telephones, electronic book readers, desktop PCs, laptop PCs, netbook computers, workstations, servers, personal digital assistants (PDAs), portable multimedia players (PMPs), MP3 players, mobile medical devices, cameras, wearable devices (e.g., electronic glasses, or head-mounted-devices (HMDs), electronic apparel, electronic bracelets, electronic necklaces, electronic appcessories, electronic tattoos, smart mirrors, smart watches, and the like.

In some embodiments, an electronic device may be a smart home appliance. The smart home appliance, for example, may include at least one of televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, Google TV™, and the like), game consoles (e.g., Xbox™, PlayStation™, and the like), electronic dictionaries, electronic keys, camcorders, electronic picture frames, and the like.

In other embodiments, an electronic device may include at least one of diverse medical devices (e.g., portable medical measuring instruments (blood-sugar measuring instruments, heart-pulsation measuring instruments, blood-pressure measuring instruments, or body-temperature measuring instruments), magnetic resonance angiography (MRAs) equipment, magnetic resonance imaging (MRI)equipment, computed tomography (CT) equipment, scanners, and ultrasonic devices), navigation device, global positioning system (GPS) receiver, event data recorder (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs) for financial agencies, points of sales (POSs) for stores, and internet of things (e.g., electric bulbs, diverse sensors, electric or gas meter, spring cooler units, fire alarms, thermostats, road lamps, toasters, exercise implements, hot water tanks, boilers, and the like).

According to some embodiments, an electronic device may include at least one of parts of furniture or buildings/structures having communication functions, electronic boards, electronic-signature receiving devices, projectors, and diverse measuring instruments (e.g., water meters, electricity meters, gas meters, and wave meters) including metal cases. In various embodiments, an electronic device may be one or more combinations of the above-mentioned devices. Electronic devices according to some embodiments may be flexible electronic devices. Additionally, electronic devices according to various embodiments of the present disclosure may not be restrictive to the above-mentioned devices, rather may include new electronic devices emerging by way of technical development.

Hereinafter, an electronic device according to various embodiments will be described in conjunction with the accompanying drawings. In description for various embodiments, the term “user” may refer to a person using an electronic device or a device (e.g., an artificial intelligent electronic device) using an electronic device.

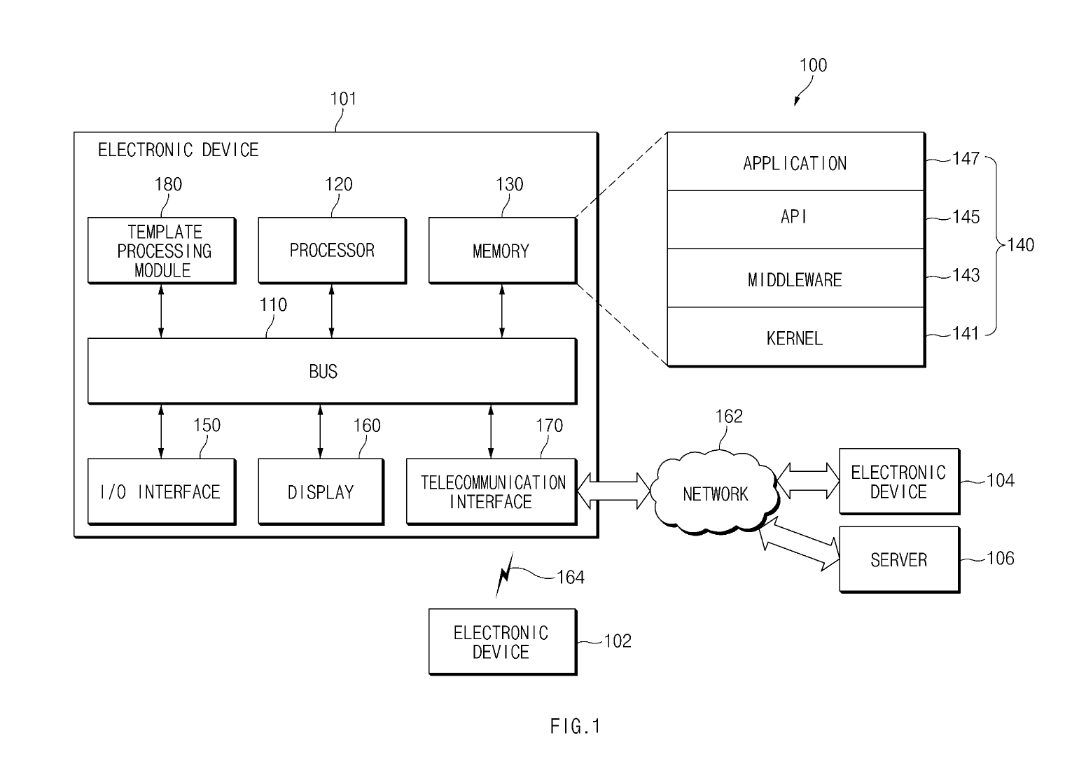

FIG. 1 illustrates an electronic device in a network environment according to various embodiments of the present disclosure.

Referring to FIG. 1, an electronic device 101 in a network environment 100 according to various embodiments of the present disclosure will be described below. The electronic device 101 may include a bus 110, a processor 120, a memory 130, an input/output (I/O) interface 150, a display 160, a communication interface 170, and a template processing module 180. In some embodiments, the electronic device 101 may exclude at least one of the elements therefrom or further include another element therein.

According to various embodiments of the present disclosure, the electronic device 101 may generate a template, which is used in an application, through the template processing module 180. The template may be a data input format which is usable in an application through a writing-in with diverse information by a user. One template may include many fields for information input. A user may confirm and store a template whose fields are automatically written without application changeover while using applications such as message application, and so on. Additionally, a user may transmit stored files to an external electronic device and may allow the files to be used in the external electronic device.

The bus 110, for example, may include a circuit for connecting the elements 110˜170 each other and relaying communication (control messages and/or data) between the elements.

The processor 120 may include at least one or more of a central processing unit (CPU), an application processor (AP), or a communication processor (CP). The processor 120, for example, may execute computation or data operation for control and/or communication of other elements of at least one of the electronic device 101.

The memory 130 may include a volatile and/or nonvolatile memory. The memory 130 may store, for example, instructions or data which are involved in at least one of other elements in the electronic device 101. In various embodiments, the memory 130 may include a template database. The template database may store information about kinds of templates referable by the template processing module 180, properties of fields of templates, lists of applications respective to templates, and so on.

According to an embodiment, the memory 130 may store a software and/or program 140 therein. The program 140 may include, for example, a kernel 141, a middleware 143, an application programming interface (API) 145, and/or an application program (or “application”) 147. At least a part of the kernel 141, the middleware 143, or the API 145 may be referred to as an operation system (OS).

The kernel 141 may control or manage, for example, system resources (e.g., the bus 110, the processor 120, or the memory 130) which are used for executing operations or functions implemented in other programs (e.g., the middleware 143, the API 145, or the application program 147). Additionally, the kernel 141 may provide an interface capable of controlling or managing system resources by approaching individual elements of the electronic device 101 from the middleware 143, the API 145, or the application program 147.

The middleware 143 may perform a mediating function to allow, for example, the API 145 or the application program 147 to communicate and exchange data with the kernel 141. Additionally, in relation to work requests received from the application program 147, the middleware 143 may perform, for example, a control operation (e.g., scheduling or load balancing) for the work request by using a method of designating or arranging the priority, which permits the electronic device 101 to use a system resource (e.g., the bus 110, the processor 120, or the memory 130), into at least one application of the application program 147.

The API 145 may be, for example, an interface for allowing the application 147 to control a function which is provided from the kernel 141 or the middleware 143. For example, the API 145 may include at least one interface or function (e.g., instructions) for file control, window control, or character control.

The input/output interface 150 may act, for example, an interface capable of transferring instructions or data, which are input from a user or another external device, to another element (or other elements) of the electronic device 101. Additionally, the input/output interface 150 may output instructions or data, which are received from another element (or other elements) of the electronic device 101, to a user or another external device.

The display 160 may include, for example, a liquid crystal display (LCD), a light emitting diode (LED), an organic LED (OLED) display, a microelectromechanical system (MEMS) display, or an electronic paper. The display 160 may display, for example, diverse contents (e.g., text, image, video, icon, or symbol) to a user. The display 160 may include a touch screen, and for example receive an input of touch, gesture, approach, or hovering which is made by using an electronic pen or a part of a user's body.

According to various embodiments of the present disclosure, the display 160 may output images which are generated from diverse applications 147. The template processing module 180 may display template list usable by a user, or templates for information input on a part of an application playing screen.

The communication interface 170 may set, for example, a communication condition between the electronic device 101 and an external electronic device (e.g., a first external electronic device 102, a second external electronic device 104, or a server 106). For example, the communication interface 170 may communicate with an external electronic device (e.g., the second external electronic device 104 or the server system 106) in connection with a network 162 through wireless communication or wired communication.

The wireless communication may use, for example, at least one of LTE, LTE-A, CDMA, WCDMA, UMTS, WiBro, or GSM. The wired communication may include, for example, at least one of universal serial bus (USB), high definition multimedia interface (HDM), recommended standard 232 (RS-232), or plain old telephone service (POTS). The network 162 may include a telecommunication network, for example, at least one of a computer network (e.g., LAN or WLAN), Internet, or a telecommunication network.

Each of the first and second external electronic devices 102 and 104 may be same with or different from the electronic device 101. According an embodiment, the server 106 may include a group of one or more servers. According to various embodiments, all or a part of operations executed in the electronic device 101 may be executed in another one or a plurality of electronic devices (e.g., the electronic device 102 or 104, or the server 106). According to an embodiment, in case there is a need of performing a function or service automatically or by a request for the electronic device 101, the electronic device 101 may request at least a part of the function or service, additionally or instead of executing by itself, from another device (e.g., the electronic device 102 or 104, or the server 106). Such another device (e.g., the electronic device 102 or 104, or the server 106) may execute such a requested or additional function and then transfer a result of the execution of the function. The electronic device 101 may process a received result, as it is or additionally, to provide the request function or service. To this end, for example, it may be available to adopt a cloud computing, distributed computing, or client-server computing technique.

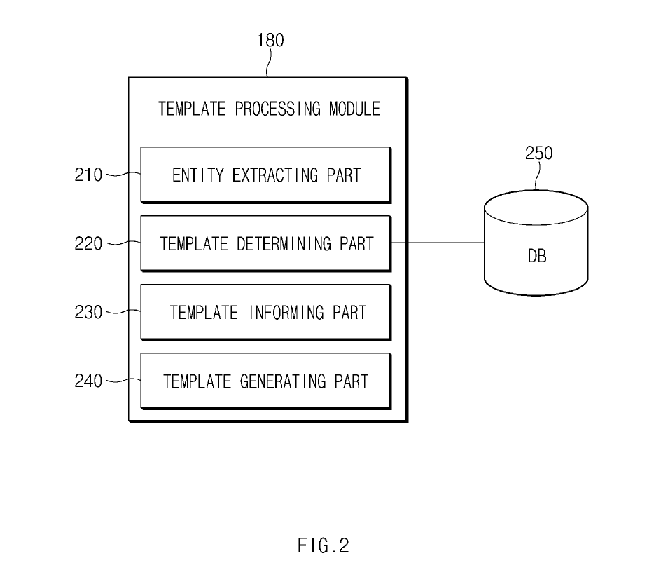

The template processing module 180 may display template list, which are selectable by a user, on the display 160. If at least one template is selected by a user, the template processing module 180 may generate a template in which at least a part of fields included in the template is automatically written. The template processing module 180 may automatically write parts of currently output contents or voice-recognized contents into a template. A user may confirm and store contents of a template, without additional screen changeover, or transmit the contents of the template to another person. Additional features about configurations and operations of the template processing module 180 will be further described in conjunction with FIGS. 2 to 10.

Although FIG. 1 is illustrated as the template processing module 180 is isolated from the processor 120, various embodiments of the present disclosure may not be restrictive hereto. For example, functions performed by the template processing module 180 may be partly or entirely executed in the processor 120.

FIG. 2 is a block diagram illustrating a template processing module 180 according to various embodiments of the present disclosure.

Referring to FIG. 2, the template processing module 180 may include an entity extracting part 210, a template determining part 220, a template informing part 230, and a template generating part 240. This segmentation on configuration is based on functions and may be arranged in partial consolidation or isolation.

In various embodiments, the template processing module 180 may further include a template database 250. The template database 250 may be added as a part of the template processing module 180, or may be included in the memory 130 of FIG. 1.

The entity extracting part 210 may extract entities (or data entities) from contents (e.g., texts displayed on a screen or voice-recognized contents) output or identified through the electronic device 101. The entity(or the data entity) may be a specific element (e.g., personal name, organization title, place, time expression, currency, mass, percentage, etc.) of contents which are recognized by voice or displayed on a screen while diverse applications, such as call applications or text applications such as message, SNS, and group chatting, are playing. The entity extracting part 210 may analyze contents of a text output on a screen or contents identified by voice, and may extract entities from information effectively usable by a user.

In the case of sequentially transmitting or receiving diverse messages for a message application, the entity extracting part 210 may extract entities from texts included in the transmitted or received messages, or may extract entities from texts currently input for transmission.

Otherwise, in the case that a user is playing a call application for a telephone call, the entity extracting part 210 may extract entities from contents talked by a transmitter or receiver (the user or the other party).

The entity extracting part 210 may employ diverse techniques for extracting entities from contents input by text or voice. For example, the entity extracting part 210 may extract an entity from characters or sentences placed ahead of a specific term (e.g., extracting “6 o'clock”, which is ahead of “until” of “until 6 o'clock”, therefrom as an entity relevant to time), or may extract by parsing each sentence and determining whether the parsed sentence is identical to data stored in an additional database. The entity extraction technology is example and various embodiments of the present disclosure may not be restrictive hereto. For example, the entity extracting part 210 may determine the priority of highly identifiable words based on information input into an electronic device by a user, and may extract entities based on the priority.

According to various embodiments, entities may have specific properties. For example, entities, such as 7 o'clock, 10 o'clock, 9 o'clock, 3 o'clock, and so on, may have a time property, and entities, such as Gangnam station, our house, Seocho-dong, may have a place property. An entity property may be previously defined or may be defined by a user.

The template determining part 220 may confirm a property (or type) of extracted entities and may determine lists of templates or applications to be displayed on a screen based on the property. The template determining part 220 may confirm a property of extracted entities and a property of a field included in a template, and may determine a template list including a field which agrees with the property. In various embodiments, the template determining part 220 may determine a template list with reference to information stored in the template database 250.

The template informing part 230 may display a determined template list (or an application list relevant to a determined template) on a display 160. In various embodiments, for a message application, the template informing part 230 may dispose a template list adjacent to an input window through which a user inputs a text. A user may select and a template from a template list. For another example, for a call application, the template informing part 230 may divide a screen, may display call information (e.g., name of the other party, call number, etc.) in a first area, and may display a template list in a second area. If a user selects one template from a template list, the selected template may be displayed in the second area.

According to various embodiments, the template informing part 230 may output a template list in a specific order. For example, the template informing part 230 may dispose templates, which are employed in frequently used applications, at the front of the template list while disposing templates, which are employed in rarely used applications, at the rear of the template list. In various embodiments, the template informing part 230 may differently display icon sizes of applications, which are included in a template list, based on the priority.

If a user selects one template from a template list, the template generating part 240 a template where fields are partly filled up. The template generating part 240 may write a part of a text (or a part of contents voice-recognized and stored in a buffer), which is being output on a screen, into a specific field.

According to various embodiments, the template generating part 240 may generate a template whose fields are partly written with extracted entities. A user may use an automatically input template without modification, or may use a template with partial modification (e.g., writing-in of additional information). Information input into the template may be transmitted to an electronic device (e.g., the electronic device 102 or 104) of another user and may be used in an application playing in the electronic device 101. A user may simply add schedule, alarm, memo, and so on, and may transmit stored schedule, and so on to the other party.

The template database 250 may store kinds of template usable in diverse applications, information about fields of templates, or information about applications capable of using templates. In the case that an extracted entity property is identical to a field property, the template determining part 220 may determine a template list including the corresponding field.

According to various embodiments, the electronic device includes a display, and a template processing module to display a template list usable in the display, such that if at least one is selected from the template list, the template processing module generates a template where at least a part of fields is filled up. The template processing module includes an entity extracting part to extract an entity from contents, a template informing part to display the template list on the display, and a template generating part to generate a template where a least a part of the fields is filled up with the entity.

According to various embodiments, the template processing module includes a template determining part to determine the template list based on a property of the entity, such that the template informing part displays a list determined by the template determining part. The template processing module further includes a template database, such that the template determining part determines the template list with reference to the template database. The template determining part determines the template list based on a property of the entity and a field property of a template stored in the template database.

According to various embodiments, the template generating part stores user data for an application relevant to the template. The application includes at least one of schedule application, memo application, alarm application, and telephone number application. The template generating part transmits a file, which includes the user data, to an external electronic device if a specific event occurs. The file has a specific file format usable in a specific application.

According to various embodiments, the template informing part displays the template list in a specific order or an order determined according to a user's type of using an application. The template generating part writes at least a part of the fields as information stored in an additional application.

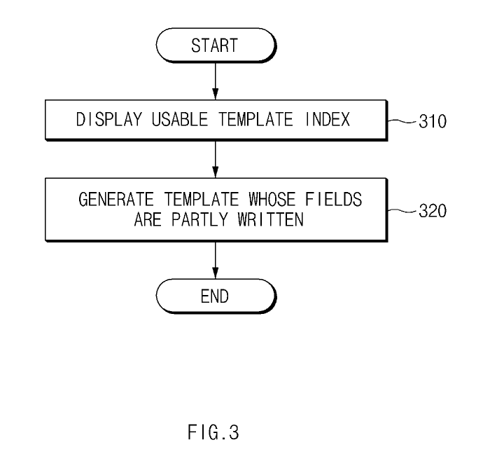

FIG. 3 is a flow chart showing a template generation process according to various embodiments of the present disclosure.

Referring to FIG. 3, at operation 310, a template informing part 230 may display a usable template list. The template informing part 230 may a template list or a list of applications using templates through icon or a text. For example, in the case of desiring to store additional information while inputting a text such as a lettered message or while calling another one, a user may select a displayed icon and may select a template.

At operation 320, if at least one template is selected by a user, a template generating part 240 may generate a template whose fields are partly written. In various embodiments, the template generating part 240 may generate a template by writing information stored through voice recognition, information extracted from a screen of a playing application, or information (e.g., information stored in an address application, information stored in a memo application, etc.), which is stored in an electronic device 101, in a part of fields.

A user may confirm written information, may partly correct the contents in need, and may store data, which are written in a template, without additional correction. The stored information may be used in an internal application of the electronic device 191 or may be transmitted to an electronic device (e.g., an electronic device 102 or an electronic device 104) of the other party.

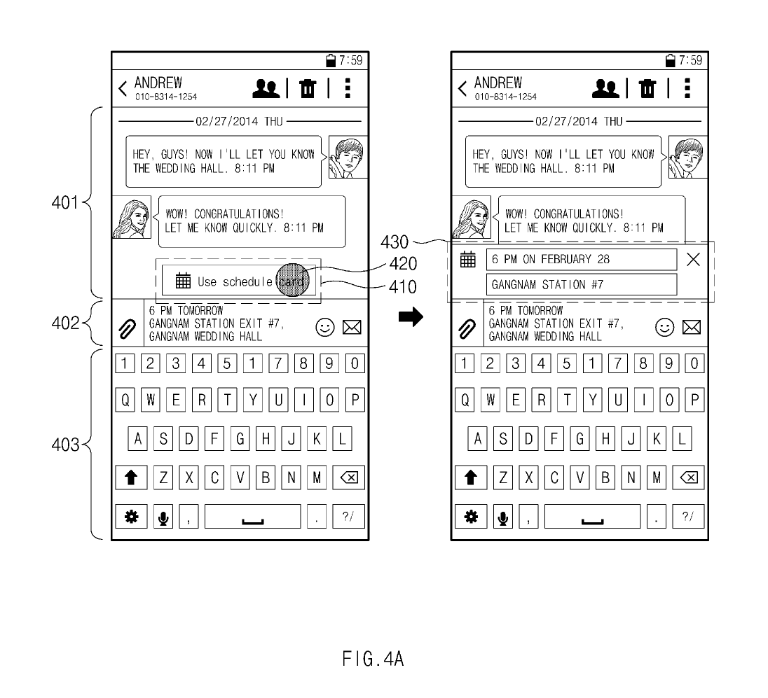

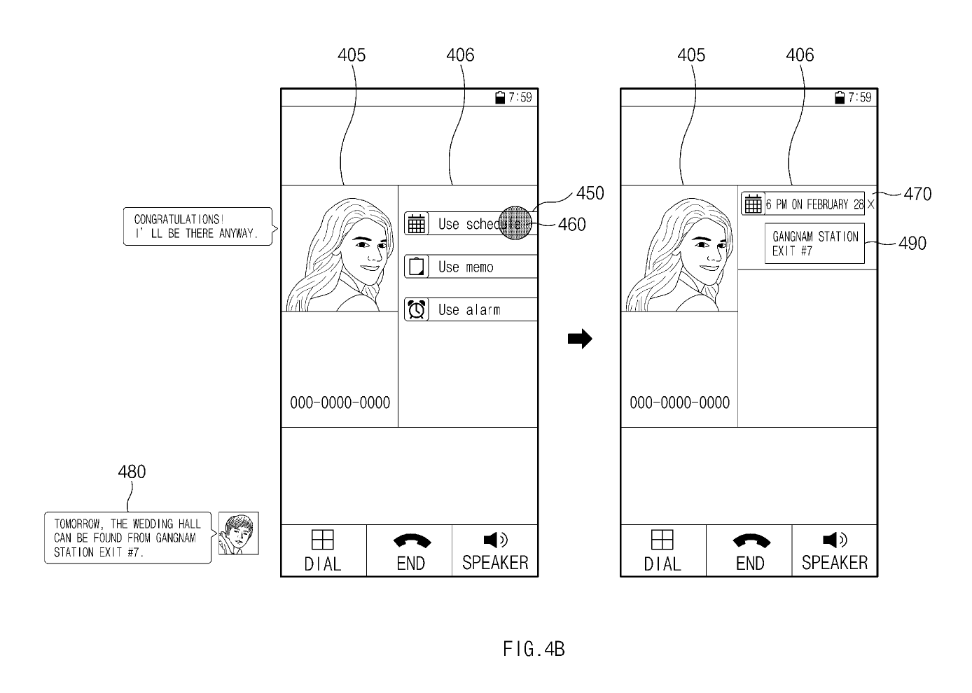

FIG. 4A is an example diagram illustrating a template generation process in a message application according to various embodiments of the present disclosure. Although FIG. 4 is illustrated as for a message application, various embodiments of the present disclosure may not be restrictive hereto.

Referring to FIG. 4A, a user may transmit/receive messages to/from the other party through a message application. Transmitted and received messages 401 may be continuously updated on a screen, and a user may input a desired message through an additional text input window 402 and a keyboard application 403 for text input. A template informing part 230 may display a template list 410, which is selectable by a user, near, adjacent to, and/or around the text input window 402. Although FIG. 4A is illustrated as for the case of displaying a schedule input template usable in a schedule application, various embodiments of the present disclosure may not be restrictive hereto. For example, the template list 410 may include a plurality of templates relevant to memo application, alarm application, and so on.

If a user selects a schedule input template through a touch input 420, a template generating part 240 may generate a template 430 having input fields that are partly written/filled. The template generating part 240 may generate the template 430 with information (e.g., time information or place information) extracted from a screen of another executing application, or with information (e.g., names or telephone numbers stored in an address application) stored in an electronic device 101.

A user may confirm written information and may store information input into a template. The stored information may be used in an internal application of the electronic device 101 or may be transmitted to an electronic device (e.g., an electronic device 102 or an electronic device 104). A user may store or transmit user information through a template in which the contents of the respective fields are automatically written/filled-in, and thus the invention facilitates easily addition of schedules, and other like templates, without requiring cumbersome and additional application changeover and/or switching.

FIG. 4B is an example diagram illustrating a template generation process in a call application according to various embodiments of the present disclosure. Although FIG. 4B is illustrated as for a call application, various embodiment of the present disclosure may not be restrictive hereto. For example, it may be applicable to voice recording applications, voice recognition applications (e.g., S Voice, Google Now, Siri, etc.).

Referring to FIG. 4B, a user may execute an active call with the other party through a call application. In the call application, a first area 405 may display call information (e.g., name, telephone number, call time of the other party) and a second area 406 may display a template list 450.

The template informing part 230 may display the template list 450 usable in the second area 406. Although FIG. 4B is example illustrated as for the case of displaying a template list usable in a schedule application, a memo application, or an alarm application, various embodiments of the present disclosure may not be restrictive hereto.

If a user selects a schedule input template through a touch input 460, the template generating part 240 may generate a template 470, whose fields are at least partly written/filled-in automatically, in the second area 406. For example, the template generating part 240 may write/fill-in and display a part of the various content within in the field of a template (e.g., time information or place information), corresponding to matters discussed by the user or the other party.

A user may confirm the written information and store information input into the template. The stored information may be used in an internal application of an electronic device 101, or may be transmitted to an electronic device (e.g., an electronic device 102 or an electronic device 104) of the other party.

In various embodiments, the second area 406 may be converted entirely or enlarged to a larger window. In this case, the template generating part 240 may additionally display words that are voice-recognized from the call and stored, thereby allowing a user to select and utilize the stored words for entering information into the template, as seen for example in elements 480 and 490.

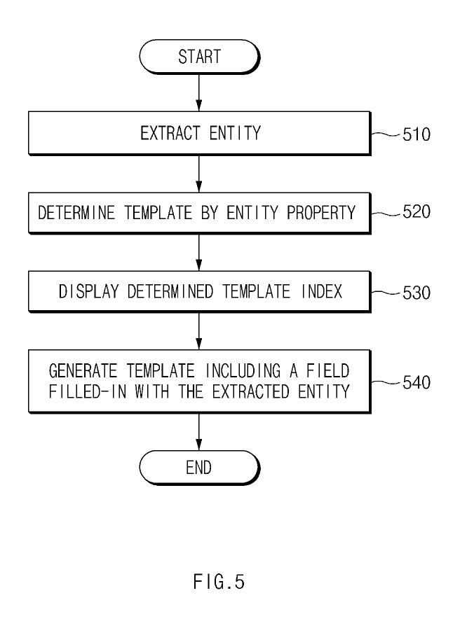

FIG. 5 is a flow chart showing a template display and generation process using entities according to various embodiments of the present disclosure.

Referring to FIG. 5, at operation 510, an entity extracting part 210 may extract entities from texts displayed on a screen, or from voice-recognized contents. The entity may be a specific element (e.g., personal name, organization title, place, time expression, currency, mass, percentage, etc.) of contents which are recognized by voice or displayed on a screen while diverse applications, such as call applications or text applications such as message, SNS, and group chatting, are playing.

At operation 520, a template determining part 220 may confirm a property of an extracted entity and may determine a template list, which is to be displayed on a screen, based on the property. The template determining part 220 may confirm a property of extracted entities and a property of a field included within the template, and then may determine a template list, which includes a field corresponding with the property, and a list of applications usable by the template.

At operation 530, the template informing part 230 may display a determined template list (or a list of applications relevant to a determined template) on a display 160. A user may select at least one template from a displayed list.

At operation 540, if a user selects one from a template list, a template generating part 240 may generate a template whose fields are partly written/filled-in with extracted entities. A user may utilize the generated template without adding additional inputs, or alternatively, the user may utilize the generated template including additional modifications or entering additional information.

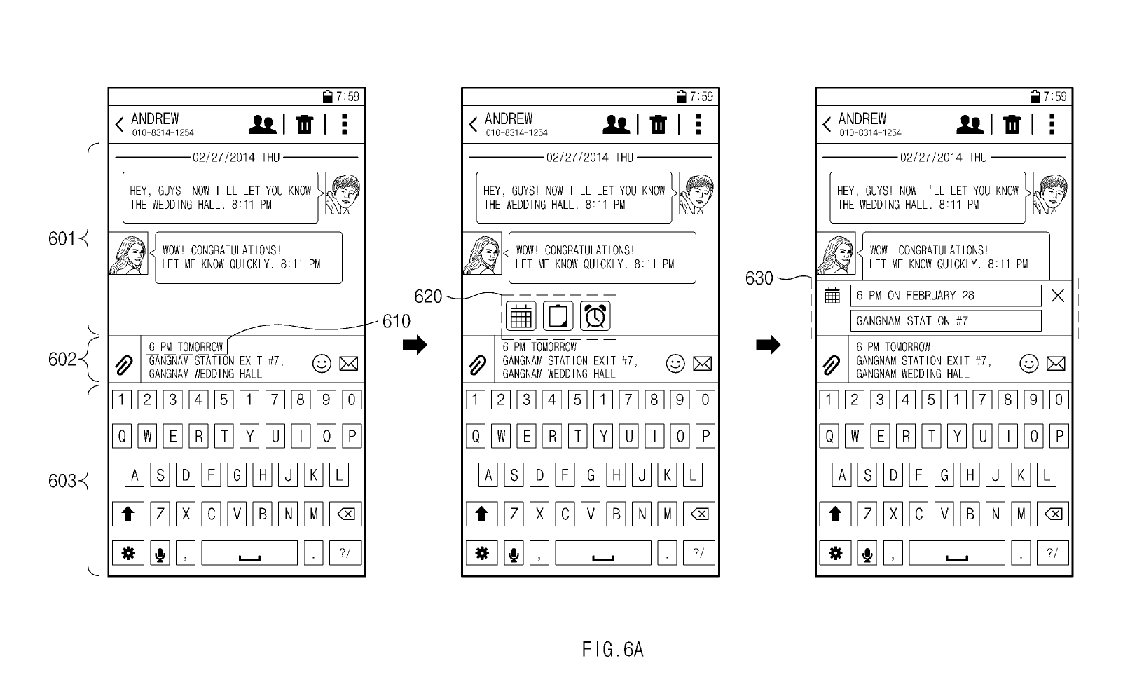

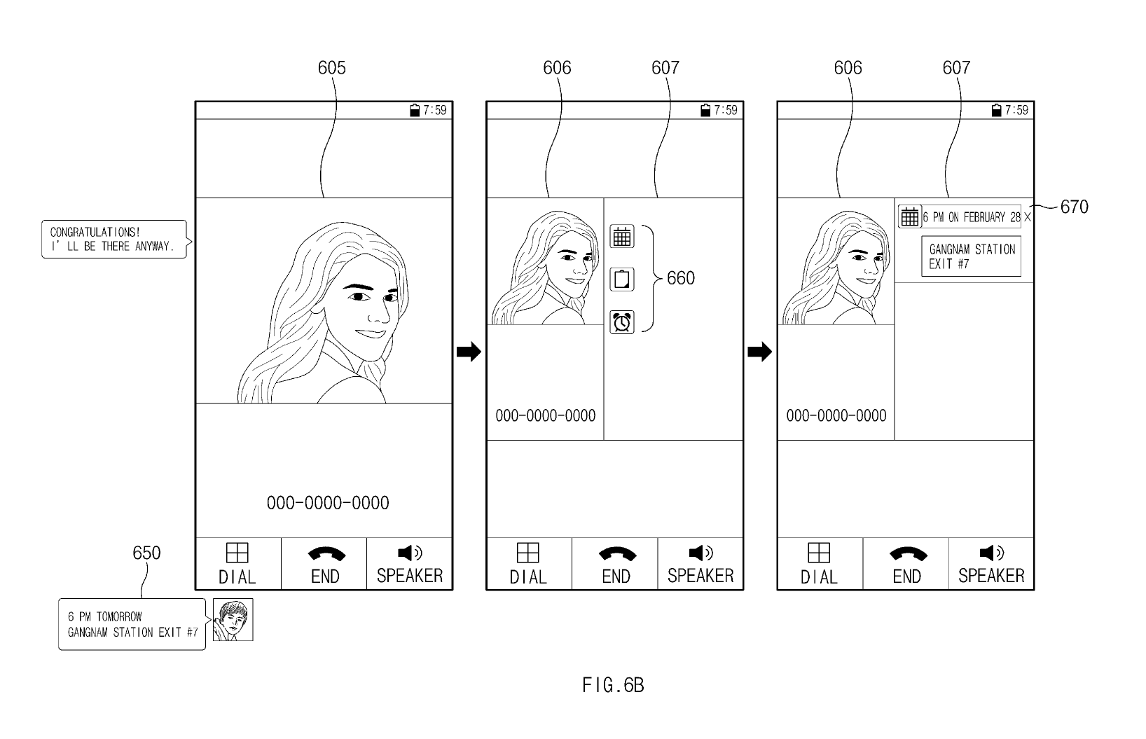

FIG. 6A is an example diagram illustrating a template generation process using entities in a message application according to various embodiments of the present disclosure. Although FIG. 6A is illustrated as for a message application, various embodiments of the present disclosure may not be restrictive hereto.

Referring to FIG. 6A, a user may transmit/receive messages to/from another person through a message application. Transmitted and received messages 601 may be continuously updated on a screen, and a user may input a desired message through an additional text input window 602 and a keyboard application 603 for text input.

An entity extracting part 210 may extract an entity 610 respectively from time information (e.g., 6 pm tomorrow) and place information (e.g., Gangnam station Exit #7) which are written in the text input window 602. Various embodiments of the present disclosure may not restrictive hereto and otherwise the entity extracting part 210 may extract the entity 610 as diverse information, such as attendant information, telephone numbers, and so on, from the transmitted and received messages 601.

The template determining part 220 may confirm a property of the extracted entity 610 and may determine a template list 620 to be displayed on a screen based on the property. The template determining part 220 may confirm that the extracted entity 610 has a time property or a place property, and may match the entity 610 with a template which has a time property or a place property. In various embodiments, the template determining part 220 may determine a matching template with reference to a template database 250.

A template informing part 230 may display the template list 620, which is usable by a user, around the text input window 602. Although FIG. 6A is illustrated for the case of displaying templates usable in schedule applications, memo applications, or alarm applications, various embodiments of the present disclosure may not be restrictive hereto. It also allows display of various types of templates or applications using time properties or place properties.

If a user selects one template (e.g., schedule input template) from the template list 620, a template generating part 240 may generate a template 630 whose fields are partly written/filled-in with extracted entities (e.g., 6 pm tomorrow, Gangnam station Exit #7). In various embodiments, the template generating part 240 may convert extracted entities into a data format, which is utilized in the template or application, and may input the formatted data. For example, in the case that an extracted entity is “6 pm tomorrow”, the template generating part 240 may automatically convert the extracted entity into the indicated time and date—that is, based on the current time, it may determine that “6 pm tomorrow” indicates “6 pm on February 28”.

A user may confirm information which is written in the template 630, and may store field contents, optionally inputting partial corrections or modifications as needed. A user may transmit the stored information to an external electronic device (e.g., an electronic device 102 or 104) and may add schedules, etc. without additional application changeover or screen changeover.

According to various embodiments, the template generating part 240 may store the template 630 in a specific file format (e.g., “vcs” files) simultaneously with the occurrence of an event such as message transmission, even though a user does not additionally store the template 630. The stored file may be transmitted to an electronic device (e.g., an electronic device 102 or 104) of the other party together with a message. The other party may add the corresponding file to a respective schedule application on their own electronic device, and may simply and directly use the corresponding file therein.

FIG. 6B is an example diagram illustrating a template generation process using entities in a call application according to various embodiments of the present disclosure. Although FIG. 6B is illustrated as for a call application, various embodiments of the present disclosure may not be restrictive hereto.

Referring to FIG. 6B, a user may call another person via a call application. Call information (e.g., name, telephone number, and call time of the other party) may be displayed in screen 605.

The entity extracting part 210 may employ a voice recognition function (e.g., voice recognition application) to extract entities from a part of a call's contents, and may store the extracted entities in a buffer. The buffer may continue to store extracted entities or updated existing extracted entities while the call is progressing.

For example, if time information (e.g., 6 pm tomorrow) or place information (e.g., Gangnam station Exit #7) is included in contents 650 discussed by a user, the entity extracting part 210 may extract the time information or place information as data entities, respectively. Various embodiments of the present disclosure may not be restrictive hereto and otherwise the entity extracting part 210 may extract entities from a variety of information, such as attendant information, telephone numbers, and so on, in voice-recognized contents.

The template determining part 220 may confirm a property of extracted entities and may determine a template list 660 to be displayed, based on the property. For example, the template determining part 220 may confirm that extracted entities have a time property or place property, and then may match the extracted entities with a template whose field also has a time property or a place property. In various embodiments, the template determining part 220 may refer to a template database 250 and may determine a template matching therewith.

According to various embodiments, if entities are extracted from call contents, screen 605 may be divided into a first area 606 for displaying call information, and a second area 607 for displaying a template list 660. Although FIG. 6B is illustrated for the case of displaying templates usable in a schedule application, a memo application, or an alarm application, various embodiments of the present disclosure may not be restrictive hereto. According to various embodiments, the screen 605 may display a variety of templates or applications using time properties or place properties.

If a user selects one template (e.g., schedule input template) from the template list 660, the template generating part 240 may generate a template 670 whose fields are partly written/filled-in with extracted entities (e.g., 6 pm tomorrow, Gangnam station #7).

A user may confirm information which is input into the template 670, and may store field contents with partial correction or modification as needed. A user may transmit the stored information to an electronic device (e.g., an electronic device 102 or 104) and may add schedules and other such templates without additional application changeover or screen changeover.

According to various embodiments, the template generating part 240 may store information, which is included in the template 670, in a specific file format (e.g., a vcs file) at the same time of occurrence of an event such as call termination even though a user does not additionally store the information. The stored file may be transmitted to an electronic device (e.g., an electronic device 102 or 104) of the other party at the same time with call termination. The other party may add a corresponding file to a specific application and may easily use the corresponding file in the application.

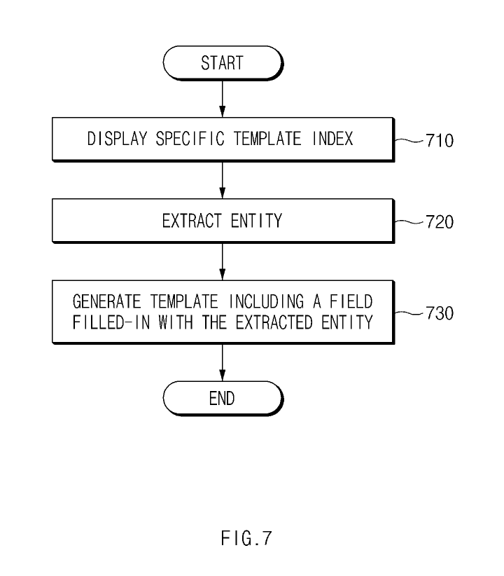

FIG. 7 is a flow chart showing a template generation process using entities according to various embodiments of the present disclosure.

Referring to FIG. 7, at operation 710, a template informing part 230 may display a template list which is selectable by a user. The template informing part 230 may display a template list or a list of applications, which use the corresponding templates, with an icon or text.

According to various embodiments, the template informing part 230 may display a template list, which is determined according to basic configuration or application usage (e.g., use frequency) of a user, without an additional entity extraction process. For example, the template informing part 230 may display icons of a schedule application, an alarm application, and a memo application in the order of applications which are most frequently adopted by a user. A user may select one from the list to generate a template in the case that the user wants to store additional information (e.g., schedules, alarms, memos, etc.) of text inputs.

At operation 720, the entity extracting part 210 may extract entities from contents. For example, in the case that a user inputs a message or transmits and receives messages, the entity extracting part 210 may continuously extract entities from the messages in a specific time interval and may update an entity list. For another example, in the case that a user is calling or recording voice, the entity extracting part 210 may continue to extract entities from contents, which are talked by the user or the other party, in a specific time interval and may update an entity list.

At operation 730, if at least one template is selected by a user, a template generating part 240 may generate a template whose fields are partly written with the entities. The template generating part 240 may confirm a property of extracted entities and a property of fields included in the corresponding template, and if the extracted entities are identical to the fields in property, the template generating part 240 may input the entities into the corresponding fields. A user may use a template which is automatically input without an additional input, or may use a template by additional correction or addition of information.

According to various embodiments, a template generation method performed in an electronic device includes extracting an entity from contents, determining a template list usable based on the extracted entity, displaying the determined template list, and generating a template where at least a part of fields is written with the entity.

According to various embodiments, the determining of the template list includes referring to a template database to store a template that is usable by the electronic device. The referring to the template database includes determining whether a property of the entity is identical to a property of a field of a template stored in the template database.

According to various embodiments, a template generation method performed in an electronic device includes displaying a usable template list on a display, extracting an entity from contents, and generating a template where at least a part of fields is written with the entity. The generating of the template includes inputting the entity into the field if the entity is identical to the field in property.

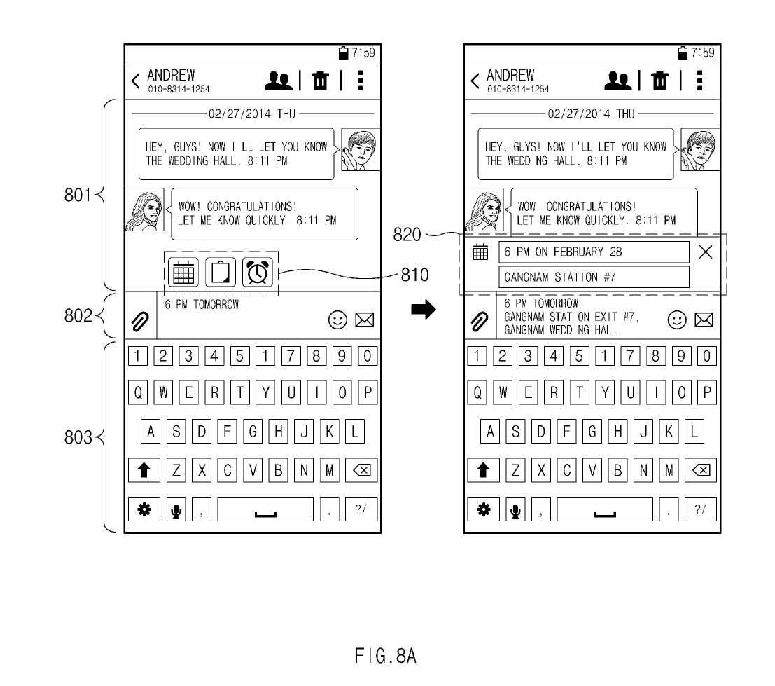

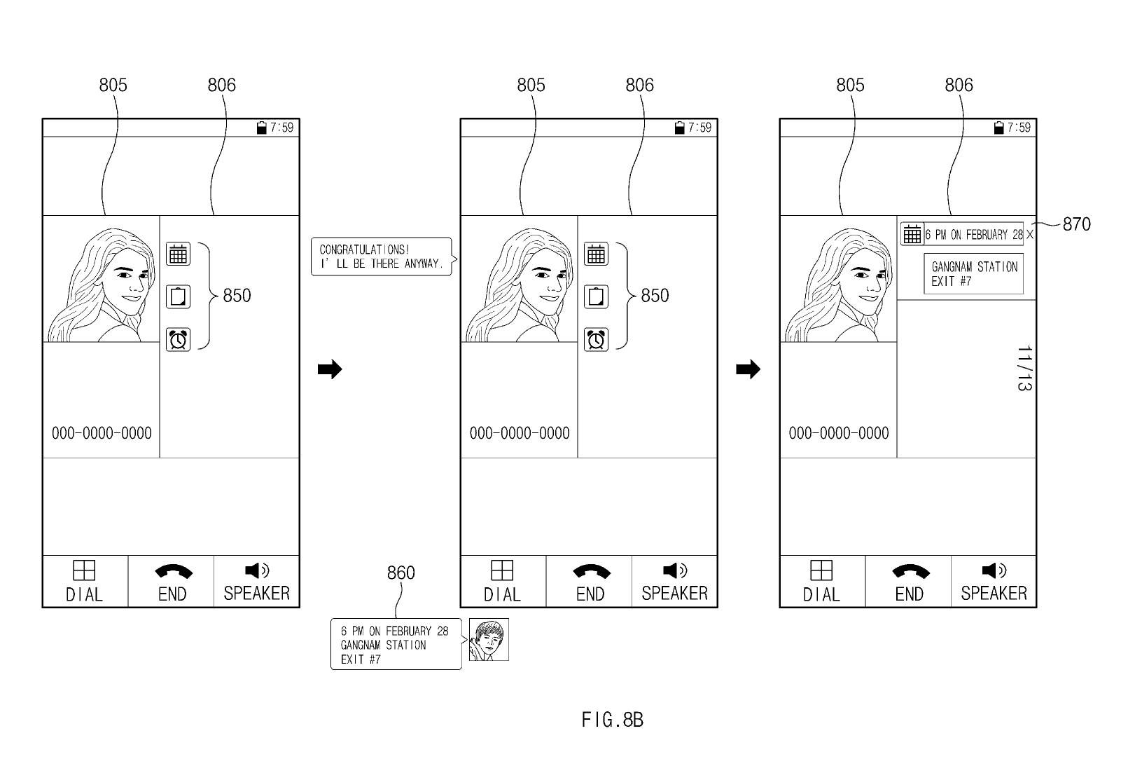

FIG. 8A is an example diagram illustrating a template generation process using entities in a message application according to various embodiments of the present disclosure.

Referring to FIG. 8A, a user may transmit/receive messages to/from another person through a message application. Transmitted and received messages 801 may be continuously updated on a screen, and a user may input a desired message through an additional text input window 802 and a keyboard application 803 for text input.

A template informing part 230 may display a template list 810 including a plurality of representative icons, which is employable by a user, around the text input window 802. Although FIG. 8A is illustrated as for the case of displaying templates usable in a schedule application, a memo application, and an alarm application, various embodiments of the present disclosure may not be restrictive hereto. The template list 810 may be sequentially arranged in basic configuration or application usage (e.g., use frequency) of a user.

In the case that a user inputs a message or transmits and receives messages, an entity extracting part 210 may continuously extract entities from the transmitted and received messages (e.g., 6 pm tomorrow, Gangnam station Exit #7). This may be done by extracting entities according to a specific periodic time interval, and the extracted entities may then be displayed to update a displayed entity list.

If a user selects one template (e.g., schedule input template) through a touch input, a template generating part 240 may generate a template 820 whose fields are partly written/filled-in with extracted entities or entities (e.g., 6 pm on February 26, Gangnam station Exit #7), which may be converted into a particular or desirable format. In the case that extracted entities are identical to fields of a corresponding template in property, the template generating part 240 may automatically input the entities into the corresponding fields, and may provide the corresponding template to a user.

FIG. 8B is an example diagram illustrating a template generation process using entities in a call application according to various embodiments of the present disclosure.

Referring to FIG. 8B, a user may call with the other party through a call application. A first area 805 may display call information (e.g., name, telephone number, call time of the other party) and a second area 806 may display a template list 850.

A template informing part 230 may display the template list 850, which is selectable by a user, in the second area 806. Although FIG. 8B is illustrated as an example case for displaying templates usable with a schedule application, a memo application, and an alarm application, the various embodiments of the present disclosure are understood as not being restricted to these. The template list 850 may be sequentially arranged in a basic configuration, or based on an application usage (e.g., use frequency) of a user.

An entity extracting part 210 may extract entities (e.g., 6 pm tomorrow, Gangnam station Exit #7, and so on) from call contents 860, via, for example, voice recognition, as indicated above. The extracted entities may be stored in an additional buffer. The template informing part 230 may update the template list 850 according to a specific time interval (also described above), based on the entities stored in the buffer.

If a user selects one template (e.g., schedule input template) through, for example, a touch input, a template generating part 240 may generate a template 870 whose fields are partly written/filled-in with extracted entities or entities (e.g., 6 pm on February 28, Gangnam station Exit #7) converted into a desirable format. In the case that extracted entities are identical to fields of a corresponding template in property, the template generating part 240 may write/fill-in the entities into the corresponding fields and may provide the corresponding template to a user.

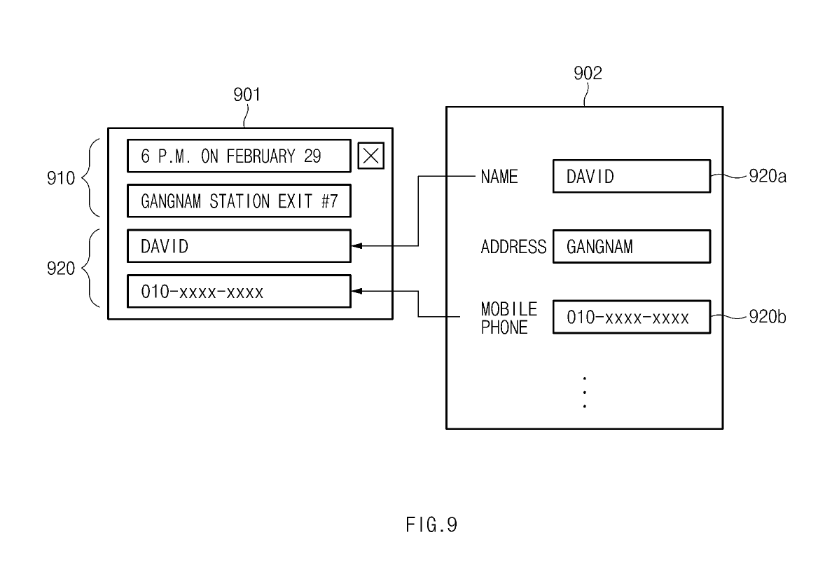

FIG. 9 is an example diagram illustrating a template generation process according to various embodiments of the present disclosure.

Referring to FIG. 9, a template generating part 240 may a template 901 which is written with information extracted by the entity extracting part, as well as information stored by other applications relevant thereto. The template 901 may include first information 910 which is written through extracted entities, and second information 920 which is appended through an additional application 902.

For example, while a message application is playing, the template generating part 240 may automatically write time and space information, which are extracted by the entity extracting part 210, into the template 901 as the first information 910. Additionally, in the case that the other party of a message application is “David” 920a, the template generating part 240 may request additional information (e.g., mobile telephone numbers, e-mail addresses, etc.) of “David” from an address application and may automatically write the additional information into other fields of the template 901. Similarly, in case that the other party has a mobile phone number “010-xxxx-xxxx” 90b, the template generating part 240 may enter that into the requisite portion of the template 901 as well.

According to various embodiments, the template generating part 240 may separately store the first information 910, which is relevant to extracted entities, into a file to be transmitted to an external electronic device, and may store information, which includes both the first information 910 and the second information 920, into a file to be used in an electronic device 101 of a user.

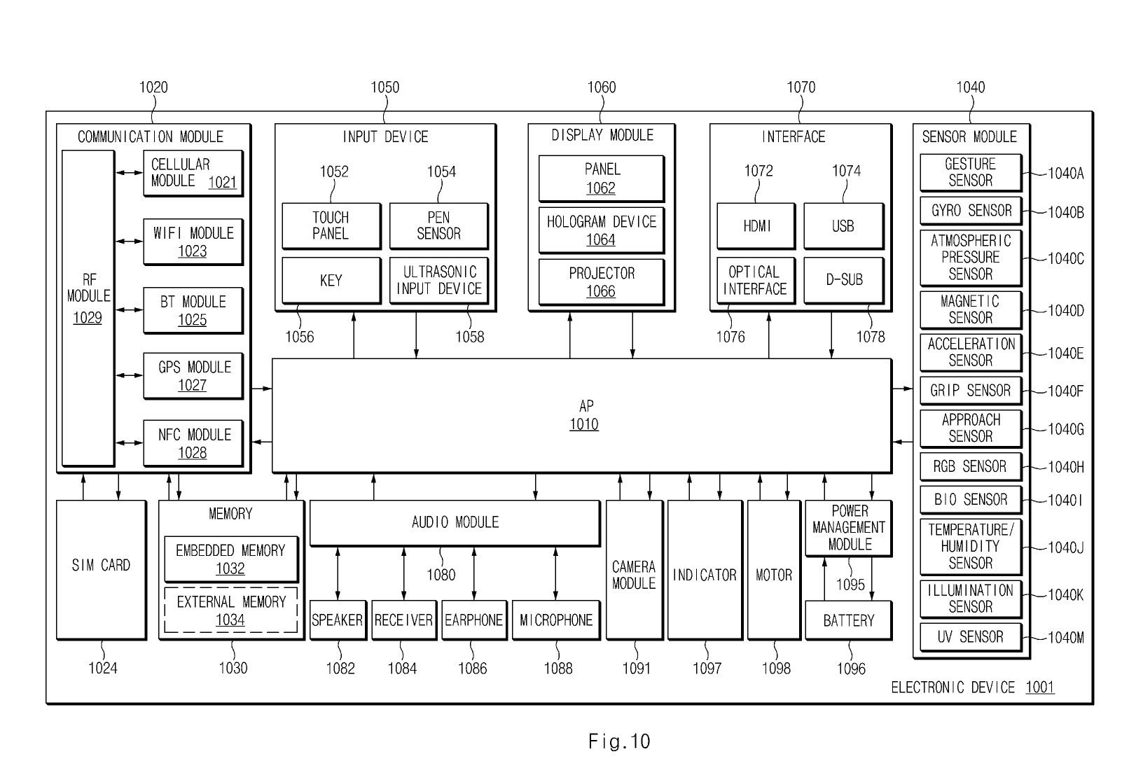

FIG. 10 is a block diagram illustrating an electronic device 1001 according to various embodiments of the present disclosure.

Referring to FIG. 10, the electronic device 1001 may include, for example, all or a part of elements of the electronic device 101 shown in FIG. 1. The electronic device 1001 may include an application processors (AP) 1010, a communication module 1020, a subscriber identification module (SIM) card 1024, a memory 1030, a sensor module 1040, an input unit 1050, a display 1060, an interface 1070, an audio module 1080, a camera module 1091, a power management module 1095, a battery 1096, an indicator 1097, or a motor 1098.

The AP 1010, for example, may drive an operating system or an application program to control a plurality of hardware or software elements connected to the AP 1010, and may process and compute a variety of diverse data. The AP 1010, for example, may be implemented in a system-on-chip (SoC), for example. According to an embodiment, the AP 1010 may further include a graphic processing unit (GPU) and/or an image signal processor. The AP 1010 may even include at least a part (e.g., a cellular module 1021) of the elements shown in FIG. 10. The AP 1010 may load and process instructions or data, which are received from at least one of other elements (e.g., a nonvolatile memory), and store diverse data into such a nonvolatile memory.

The communication module 1020 may be the same as or similar to the communication interface 170 of FIG. 1 in configuration. For example, the communication module 1020 may include a cellular module 1021, a WiFi module 1023, a Bluetooth (BT) module 1025, a GPS module 1027, an NFC module 1028, and a radio frequency (RF) module 1029.

The cellular module 1021, for example, may provide a voice call, a video call, a message service, or an Internet service through a communication network. According to an embodiment, the cellular module 1021 may perform identification and authentication of an electronic device using a subscriber identification module (e.g., a SIM card 1024) in a communication network. According to an embodiment, the cellular module 1021 may perform at least a portion of functions which can be provided by the AP 1010. According to an embodiment, the cellular module 1021 may include a communication processor (CP).

Each of the WiFi module 1023, the BT module 1025, the GPS module 1027, and the NFC module 1028, for example, may include a processor for processing data transmitted and received through a corresponding module. In some embodiments, at least a part (e.g., two or more) of the cellular module 1021, the WiFi module 1023, the BT module 1025, the GPS module 1027, and the NFC module 1028 may be included in one integrated circuit (IC) or IC package.

The RF module 1029, for example, may transmit and receive communication signals (e.g., RF signals). The RF module 1029 may include a transceiver, a power amplifier module (PAM), a frequency filter, a low noise amplifier (LNA), or an antenna. According to another embodiment, at least one of the cellular module 1021, the WiFi module 1023, the BT module 1025, the GPS module 1027, and the NFC module 1028 may transmit and receive an RF signal through an additional RF module.

The SIM card 1024, for example, may include a card and/or an embedded SIM, which have/has a subscriber identification module, and include unique identifying information (e.g., integrated circuit card identifier (ICCID)) or subscriber information (e.g., integrated mobile subscriber identify (IMSI)).

The memory 1030 (e.g., the memory 130) may include, for example, an embedded memory 1032 or an external memory 1034. For example, the embedded memory 1032 may include at least one of a volatile memory (e.g., a dynamic RAM (DRAM), a static RAM (SRAM), a synchronous dynamic RAM (SDRAM), etc.), a nonvolatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a NAND flash memory, a NOR flash memory, etc.), a hard drive, or solid state drive (SSD).

The external memory 1034 may further include a flash drive, for example, a compact flash (CF), a secure digital (SD), a micro-secure digital (SD), a mini-SD, an extreme digital (xD), or a memory stick. The external memory 1034 may be functionally and/or physically connected with the electronic device 1001 through diverse interfaces.

The sensor module 1040, for example, may measure a physical quantity, or detect an operation state of the electronic device 1001, to convert the measured or detected information to an electric signal. The sensor module 1040 may include at least one of a gesture sensor 1040A, a gyro sensor 1040B, a pressure sensor 1040C, a magnetic sensor 1040D, an acceleration sensor 1040E, a grip sensor 1040F, a proximity sensor 10406₅ a color sensor 1040H (e.g., RGB sensor), a living body sensor 10401, a temperature/humidity sensor 1040J, an illuminance sensor 1040K, or an UV sensor 1040M. Additionally or alternatively, for example, the sensor module 1040 may include an E-nose sensor, an electromyography sensor (EMG) sensor, an electroencephalogram (EEG) sensor, an electrocardiogram (ECG) sensor, an infrared (IR) sensor, an iris sensor, and/or a fingerprint sensor, for example. The sensor module 1040 may further include a control circuit for controlling at least one or more sensors included therein. In some embodiments, the electronic device 1001 may further include a processor, which is configured to control the sensor module 1040, as a part of the AP 1010 or additional element, thus controlling the sensor module 1040 while the AP 1010 is in a sleep state.

The input unit 1050, for example, may include a touch panel 1052, a (digital) pen sensor 1054, a key 1056, or an ultrasonic input unit 1058. The touch panel 1052, for example, may employ at least one of a capacitive type, a resistive type, an infrared type, or an ultrasonic wave type. Additionally, the touch panel 1052 may even further include a control circuit. The touch panel 1052 may further include a tactile layer to provide a tactile reaction for a user.

The (digital) pen sensor 1054, for example, may be a part of a touch panel, or an additional sheet for recognition. The key 1056, for example, may include a physical button, an optical key, or a keypad. The ultrasonic input unit 1058 may allow the electronic device 1001 to detect a sound wave by a microphone (e.g., a microphone 1088) through an input unit which generates an ultrasonic signal, and then to find data.

The display 1060 (e.g., the display 160) may include a panel 1062, a hologram device 1064, or a projector 1066. The panel 1062 may include the same or similar configuration with the display 160 of FIG. 1. The panel 1062, for example, may be implemented to be flexible, transparent, or wearable. The panel 1062 and the touch panel 1052 may be implemented in one module. The hologram device 1064 may display a three-dimensional image in a space by using interference of light. The projector 1066 may project light to a screen to display an image. The screen, for example, may be placed in the inside or outside of the electronic device 1001. According to an embodiment, the display 1060 may further include a control circuit for controlling the panel 1062, the hologram device 1064, or the projector 1066.

The interface 1070, for example, may include a high-definition multimedia interface (HDMI) 1072, a USB 1074, an optical interface 1076, or a D-sub (D-subminiature) 1078. The interface 1070, for example, may include the communication interface 170 shown in FIG. 1. Additionally or alternatively, the interface 1070, for example, may include a mobile high definition link (MHL) interface, an SD card/multi-media cared (MMC) interface, or an Infrared data association (IrDA) standard interface.

The audio module 1080, for example, may convert a sound and an electric signal in dual directions. At least one element of the audio module 1080, for example, may be included in the input/output interface 150 shown in FIG. 1. The audio module 1080, for example, may process sound information which is input or output through a speaker 1082, a receiver 1084, an earphone 1086, or a microphone 1088.

The camera module 1091, for example, may be a unit capable of taking a still picture and a motion picture. According to an embodiment, the camera module 991 may include one or more image sensors (e.g., a front sensor or a rear sensor), a lens, an image signal processor (ISP), or a flash (e.g., an LED or a xenon lamp).

The power management module 1095, for example, may manage power of the electronic device 1001. According to an embodiment, the power management module 1095 may include a power management integrated circuit (PMIC), a charger integrated circuit (IC), a battery gauge, or fuel gauge. The PMIC may operate in wired and/or wireless charging mode. A wireless charging mode, for example, may include a type of magnetic resonance, magnetic induction, or electromagnetic wave. For the wireless charging mode, an additional circuit, such as a coil loop circuit, a resonance circuit, or a rectifier, may be further included therein. The battery gauge, for example, may measure a remnant of the battery 1096, a voltage, a current, or a temperature while the battery is being charged. The battery 1096, for example, may include a rechargeable battery and/or a solar battery.

The indicator 1097 may display specific states of the electronic device 1001 or a part (e.g., the AP 1010) thereof, for example, a booting state, a message state, or a charging state. The motor 1098 may convert an electric signal into mechanical vibration and generate a vibration or haptic effect. Although not shown, the electronic device 1001 may include a processing unit (e.g., a GPU) for supporting a mobile TV. The processing unit for supporting a mobile TV, for example, may process media data which are based on the standard of digital multimedia broadcasting (DMB), digital video broadcasting (DVB), or media flow.

Each of the above-described elements of the electronic device according to an embodiment of the present disclosure may be implemented in one or more components, and a name of a relevant component may vary according to a kind of electronic device. In various embodiments of the present disclosure, an electronic device may be formed by including at least one of the above components, may exclude a part of the components, or may further include an additional component. Otherwise, some of the components of an electronic device according to the present disclosure may be combined to form one entity, thereby making it also accomplishable to perform the functions of the corresponding components substantially in the same feature as done before the combination.

The term “module” as used herein for various embodiments of the present disclosure, for example, may mean a unit including one, or two or more combinations of hardware, software, and firmware. The term “module”, for example, may be interchangeably used with a term such as unit, logic, logical block, component, or circuit. A “module” may be a minimum unit of a component integrated in a single body, or a part thereof. A “module” may be a minimum unit performing one or more functions or a part thereof. A “module” may be implemented mechanically or electronically. For example, a “module” according to various embodiments of the present disclosure may include at least one of an application-specific integrated circuit (ASIC) chip, a field-programmable gate array (FPGA), or a programmable logic device, those of which are designed to perform some operations and have been known or to be developed in the future.

At least a part of units (e.g., modules or functions thereof) or methods (e.g., operations) according to various embodiments of the present disclosure, for example, may be implemented in instructions which are stored in a computer-readable storage medium in the form of a programmable module. In case such an instruction is executed by a processor (e.g., the processor 120), the processor may perform a function corresponding to the instruction. Such a computer-readable medium, for example, may be the memory 130.

The computer-readable recording medium may include a hard disk, a magnetic media (e.g., magnetic tape), optical media (e.g., CD-ROM, DVD, magneto-optical media (e.g., floptical disk)), or a hardware device (ROM, RAM, or flash memory). Additionally, a program instruction may include not only a mechanical code, such as a thing generated by a compiler, but also a high-level language code which is executable by a computer using an interpreter and so on. The above hardware unit may be formed to operate as one or more software modules for performing operations according to various embodiments of the present disclosure, and vice versa.

According to various embodiments, a non-transitory computer-readable storage medium includes an instruction to control an electronic device, such that the instruction allows the electronic device to perform extracting an entity from contents, determining a template list usable based on the extracted entity, displaying the determined template list, and generating a template where at least a part of fields is written with the entity.

A module or a programming module according to various embodiments of the present disclosure may include at least one of the above elements, or a part of the above elements may be omitted, or additional other elements may be further included. Operations performed by a module, a programming module, or other elements according to an embodiment of the present disclosure may be executed sequentially, in parallel, repeatedly, or in a heuristic method. Also, a portion of operations may be executed in different sequences, omitted, or other operations may be added thereto.

The various embodiments shown in the present disclosure are provided as examples to describe technical contents and help understanding but should not be construed as limiting the present disclosure to the strict embodiments alone. Accordingly, it is understood that besides the embodiments listed herein, all modifications or modified forms derived from the embodiments and the technical ideas of the present disclosure are considered included the present disclosure, as defined in the claims and their equivalents.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

What is claimed is:

1. A method in an electronic device, comprising:
extracting, by at least one processor, an entity from content;
determining a template based on a type of the extracted entity;
displaying a list of templates, each template including fields for receiving data; and
in response to determining selection of a particular template from the list, controlling the display to display the particular template, wherein the extracted entity is provided to at least one field of the determined template.

2. The method of claim 1, wherein the determining the template comprises:
querying a template database storing a plurality of templates usable by the electronic device.

3. The method of claim 2, wherein querying the template database comprises:
determining whether the type of the extracted entity is identical to a type of at least one data field of at least one template stored in the template database.

4. A method performed in an electronic device, the method comprising:
displaying a usable template list on a display;
extracting an entity from contents; and
generating a template where at least a part of fields is written with the entity.

5. The method of claim 4, wherein the generating of the template comprises:
inputting the entity into the field if the entity is identical to the field in type.

6. An electronic device comprising:
a display;
a memory; and
at least one processor coupled to the memory, configured to:
control the display to display a list of templates, each template including fields for receiving data, and
in response to determining selection of a particular template from the list, controlling the display to display the particular template wherein data is automatically provided to at least one field of the particular template.

7. The electronic device of claim 6, wherein the at least one processor is further configured to:
extract an entity from content; and
generate the particular template wherein the at least one field of the particular template is automatically filled-in with the extracted entity.

8. The electronic device of claim 7, wherein the at least one processor is further configured to:
determine the template based on a type of the extracted entity.

9. The electronic device of claim 8, wherein the electronic device further comprises a template database, the at least one processor further configured to:
determine the template with reference to the template database.

10. The electronic device of claim 9, wherein the at least one processor is further configured to determine the template by matching a type of the extracted entity with a field type of a template stored in the template database.

11. The electronic device of claim 7, wherein the at least one processor is further configured to store user data for an application relevant to the template.

12. The electronic device of claim 11, wherein the application comprises at least one of schedule application, memo application, alarm application, and telephone number application.

13. The electronic device of claim 11, wherein the at least one processor is further configured transmits a file including the user data to an external electronic device in response to occurrence of a specific event.

14. The electronic device of claim 13, wherein the file includes a specific file format usable in a specific application.

15. The electronic device of claim 7, wherein the at least one processor controls the display to display selectable icons, each representing a different template, the selectable icons arranged in a pre-determined order or an order indicated by a frequency of use of applications associated with templates represented by the selectable icons.

16. The electronic device of claim 7, wherein the at least one processor is further configured to retrieve information related with at least one application and enter the retrieved information into the at least one field of the particular template.

17. A non-transitory computer-readable storage medium including an instruction to control an electronic device, wherein the instruction causes the electronic device to perform:
extracting, by at least one processor, an entity from content;
determining a template list corresponding to a type of the extracted entity; and
displaying on a display the determined template, wherein the extracted entity is provided to at least one field of the determined template.
